(19) United States
(12) Patent Application Publication
(10) Pub. No.: US 2003/0074443 A1
(43) Pub. Date: Apr. 17, 2003

(54) Last mile quality of service broker (LMQB) for multiple access networks

(76) Inventors: Makonnen Melaku, Metuchen, NJ (US); Seshadri Mohan, Basking Ridge, NJ (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 09/977,781

(22) Filed: Oct. 15, 2001

(51) Int. Cl. G06F 15/173

(52) U.S. Cl. 709/224; 709/225

(57) ABSTRACT

The present invention relates to methods and systems for providing last mile quality of service for a network configuration with multiple access networks, i.e., networks that includes wireless access networks and/or wireline access networks. Thus, one embodiment of a network configuration according to the invention can include two wireless access networks and no wireline access networks. One version of the invention provides a method for extending quality of service to the edge of a network. The edge of the network includes a plurality of access networks. The method determines a user's presence in more than one of the plurality of access networks. The method also determines a specified QoS for the user. The method obtains QoS available data related to the QoS available from the plurality of access networks in which the user is present. At least one of the access networks is adapted to communicate with wireless devices. In addition, the method manages the edge of the network based at least in part on the specified QoS for the user and on the QoS available data.

### FIELD OF THE INVENTION

The present invention relates generally to methods and systems for providing quality of service at the edge of a network, and more specifically to methods and systems for providing last mile quality of service for multiple access networks, i.e., networks that include wireless access networks and/or wireline access networks.

### BACKGROUND OF THE INVENTION

Typical wireless networks do not provide support for Quality of Service (QoS). Thus, typical wireless networks do not enable service providers to competitively differentiate themselves with value-added services that meet the quality of service needs of both end users and of the applications that serve end users. In other words, network elements and platforms do not allow service providers to differentiate themselves through QoS support for wireless networks.

While the present generation of the public Internet offers the ‘best-effort’ service (meaning no support for QoS), the Internet Engineering Task Force (IETF) has proposed protocols to support QoS in routers. The mechanisms for QoS developed by IETF include protocols such as Resource Reservation Protocols (RSVP) described in Request for Comment (RFC) 2205 (R. Braden. Resource ReSerVation Protocol (RSVP). Network Working Group, Version 1 Functional Specification [online], [retrieved on Sep. 24, 2001]. Retrieved from the Internet<URL: http://www.cis.ohio-state.edu/cgi-bin/rfc/rfc2205.html> and incorporated herein by reference in its entirety). Other such protocols include Integrated Services (Intserv) [RFC2211, RFC2212], Differentiated Services Protocol (DiffServ) [RFC 2475], and Multiprotocol Label Switching [RFC3031]. In addition, IEEE 802.1p defines a QoS standard for wireless local area networks (WLANs), wide area networks (WANs), and local area networks (LANs).

The wireless standards bodies 3^{rd} Generation Partnership Project (3GPP) and 3GPP2 would benefit from an application of the above protocols developed in IETF to address end-to-end QOS solutions in next generation wireless networks. An end-to-end network includes the ‘last mile’ access network at both ends and the intermediate or core networks. The intermediate or core networks could include the public or private Internet, other wireline networks including the public switched telephone network (PSTN), and/or wireless networks (e.g., general packet radio service (GPRS)).

QoS signaling applied to the core network operates by either reserving resources or classifying traffic or by a combination of reservation and classification. RSVP is a QoS signaling protocol based on resource reservation and DiffServ is a protocol for specifying and controlling network traffic by class so that certain types of traffic get precedence. According to RFC 2205, the main modules of RSVP are RSVP daemon, admission control, Policy control, packet scheduler, and packet classifier.

RFC 2205 defines RSVP as a resource reservation setup protocol designed for an integrated services Internet. A host uses the RSVP protocol to request specific qualities of service from the network for particular application data streams or flows. Routers also use RSVP to deliver quality-of-service (QoS) requests to all nodes along the path(s) of the flows and to establish and maintain states to provide the requested service. RSVP requests generally reserve resources in each node along the data path.

During a QoS resource reservation request by a mobile station, the RSVP daemon consults the policy control and admission control for permission. Once this is done, it sets packet classifier and packet handler QoS attributes.

In contrast, the DiffSERV can categorize traffic based on, for example, whether the services are delay sensitive. Examples of delay sensitive services include real-time voice and video. The wireless standards organizations 3GPP & 3GPP2 have categorized services into five classes: conversational (e.g., voice), streaming (e.g., video), interactive (e.g., web browsing), background (e.g., E-mail), and signaling (e.g., IP-based signaling, RSVP).

However, despite the existence of above-mentioned QoS signaling schemes, typical or current wireless networks do not provide effective QoS for the last mile of the network. In fact, the last mile of the wireline network is generally a bottleneck in the delivery of data services to users. The last mile is even more of a bottleneck in a wireless network where the user is mobile and where bandwidth is limited. In addition, the bottleneck becomes even more severe when the data being delivered includes multimedia data because practical use of multimedia data requires a relatively large amount of bandwidth compared with other common data types. Thus, providing ‘last mile’ data services, particularly those data services that involve the transmission of multimedia data, over a mixed, i.e., wireline and wireless, network presents a significant challenge.

### SUMMARY OF THE INVENTION

The present invention relates to methods and systems for providing last mile quality of service for multiple access networks, i.e., networks that include wireless access networks and/or wireline access networks. One version of the invention provides a method for extending quality of service to the edge of a network. The edge of the network includes a plurality of access networks. The method determines a user's presence in more than one of the plurality of access networks. The method also determines a specified QoS for the user. The method obtains QoS available data related to the QoS available from the plurality of access networks in which the user is present. At least one of the access networks is adapted to communicate with wireless devices. In addition, the method manages the edge of the network based at least in part on the specified QoS for the user and on the QoS available data.

Embodiments of the present invention provide a server-based solution that addresses QoS in the last-mile network by taking into account mobility of users and diversity of access networks. Embodiments of the present invention provide methods and systems that enable a user to leverage the user's presence in various types of access networks such as wireline (telephone, cable, ADSL), LAN (wireless or wireline) to determine an appropriate access network for responding to a QoS specified for, or requested by, an end user. Embodiments of the present invention (1) coordinate QoS among multiple wireless access network, (2) track assigned and available resources and allocate them on demand dynamically based on traffic load, (3) reroute traffic to an appropriate access network based on location of the mobile user and service demand, and (4) perform traffic classification and distribution based on historical data.

### BRIEF DESCRIPTION OF THE DRAWINGS

For better understanding of the invention, reference is made to the drawings, which are incorporated herein by reference and in which:

FIG. 1 is a functional block diagram of one embodiment of a system for providing last mile Quality of Service and elements with which the system interacts;

FIG. 2 is a functional block diagram of the last mile quality of service broker (LMQB) of FIG. 1.

FIG. 3 shows one embodiment of a data structure for use with the LMQB of FIG. 1;

FIG. 4 is a functional block diagram of a client or user device for use with the system of FIG. 1;

FIG. 5 is a functional block diagram of the LMQB of FIG. 1 exchanging information with the access networks regarding resource availability;

FIG. 6 is a functional block diagram of the embodiment of FIG. 1 along with other network elements including a radio access network and a mobile service;

FIG. 7 is a functional block diagram of one embodiment of a portion of the architecture of FIG. 1 where a single LMQB supports many radio access networks and packet data serving nodes;

FIG. 8 is a functional block diagram of an embodiment similar to FIG. 7 where a single LMQB supports a next generation wireless network, a WAN, and a WLAN;

FIG. 9 is a flow sequence for the system of FIG. 1 or for the system of FIG. 6;

FIG. 10 is a flow sequence for steps 8 and 9 of FIG. 9;

FIG. 11 is a flow sequence that occurs between steps 15 and 16 of FIG. 9; and

FIG. 12 is a flow chart for the operation of one embodiment of the LMQB of FIG. 1.

### DETAILED DESCRIPTION

Embodiments of the present invention provide methods and systems that manage QoS at the edge of multiple access networks, i.e., networks that include at least one wireless access network and that can include at least one wireline access network. For example, embodiments of the present invention provide methods and systems that manage the communication between wireless device users and associated access networks in order to manage the QoS received by the wireless device users. An access network is a network that connects to the core network through a wireless or a wireline transmission. Given that wireless networks will include different types of network systems, each with its own mechanisms for control of QoS, the entities that are responsible for allocating QoS in the various network systems will need to work with each other. Embodiments of the present invention provide an intelligent QoS entity, located between the access networks and the wireless core network, that assists the mobile user in obtaining high-speed connection to the Internet or an intranet.

This intelligent QoS entity can provide resource allocation for a high-end mobile user. Such resource allocation (i.e., the ability to allocate the appropriate resource, such as an access network, to the appropriate user) becomes more important as the number of cells increases and the amount of overlap between access networks increases, since the number of access networks per user will then increase as well. Such resource allocation also becomes more important as diversified wireless infrastructures such as universal mobile telecommunication system (UMTS), wideband code division multiple access (WCDMA), Bluetooth, and high performance radio local area network (HiperLAN) evolve to allow a user to move seamlessly between the infrastructures. The diversified infrastructures noted above focus on different applications of wireless networks. For example, the European Telecommunications Standards Institute (ETSI) developed HiperLAN as a set of WLAN communication standards used chiefly in European countries. HiperLAN is similar to the IEEE 802.11 WLAN standards used in the U.S. Similar to the 802.11 standards, HiperLAN serves to ensure the interoperability of different manufacturers' wireless communications equipment operating in a specified portion of the electromagnetic spectrum.

A QoS solution for a general network can contain three parts: a network QoS, an operating system QoS, and an application QoS. The network QoS is further sub-divided into backbone QoS and wireless access QoS. The present invention relates to the application QoS.

Operating system QoS can be loosely defined as the performance of various software modules that provide a quality of service. An example of QoS for operating system will be the number of instruction cycles it takes to execute a function. This can be mapped to delay in the network.

Application QoS refers to the QoS that an application will need from the network. Applications may make use of one or more data services. These data services can be classified as streaming, conversational, interactive, and background. These classifications simplify mapping application QoS to that of network QoS. The QoS requirement of each class of service that the application uses determines the application QoS. The network treats packets generated by each application to meet the QoS requirement of each component service. For example, if one runs voice application, then the voice packets are marked as conversational. Since conversation class is highly delay sensitive, the network QoS treats these packets as delay sensitive and provides appropriate priority by suitably classifying the packets.

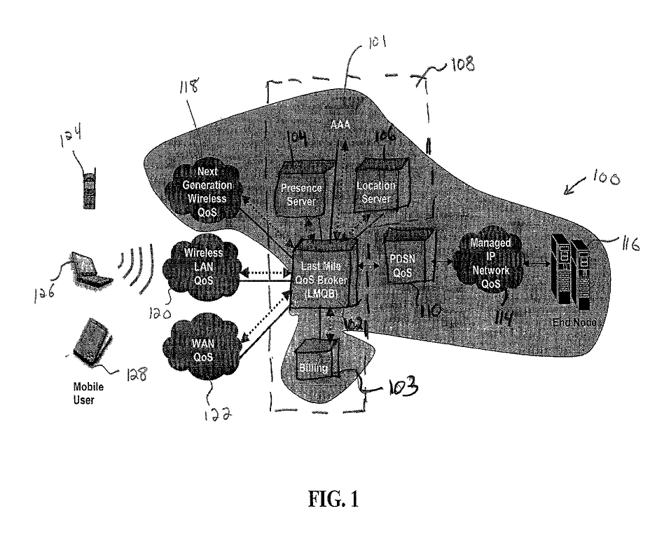

FIG. 1 depicts an architecture 100 defined from user terminals or devices 124, 126, 128 to an end node 116, e.g., an application server. According to the illustrated architecture, the user terminals 124, 126, 128 communicate with wireless access QoS elements or networks such as a next generation wireless QoS 118 (e.g., UMTS, WCDMA, ALL IP, and fourth generation (4G)), wireless LAN QoS 120, and WAN QoS 122. The present invention contemplates use in a mixed network in which user terminals communicate with wireless and/or wireline access networks. The wireless access QoS elements 118, 120, 122, in turn, communicate with Last Mile QoS broker (LMQB) 102. The LMQB 102 communicates with presence server 104, location server 106, and packet data serving node (PDSN) QoS element 110. The LMQB 102 also communicates with authentication, administration, and accounting server 101 and billing server 103. The various servers 101, 103, 104, 106 and the LMQB 102 make up one embodiment of a LMQB system 108 according to the invention.

The presence server 104 provides data related to the presence of a mobile user. Similarly, the location server provides data related to the location of a mobile user. The PDSN QoS element 110 resides in a PDSN that bridges a radio network to a managed IP network via a serving router. More specifically, the PDSN establishes, maintains, and terminates link layer sessions to a mobile client. Incremental functions include, but are not limited to, IP address assignments for Simple IP service and performing Foreign Agent functionality for a visiting mobile node for Mobile IP service. Simple IP based service mainly supports mobile node initiated dial-in. The PDSN is the 3G System interface between an access network and a data network. It terminates the data link layer from the mobile and routes upper layer protocols into a data network directly.

With reference to the embodiment illustrated in FIG. 1, PDSN QoS element 110 communicates with managed IP network QoS element 114, which in turn communicates with end node 116. The LMQB 102 organizes traffic traveling through the network architecture 100 per standard classes of services as in 3GPP/3GPP2 classifications.

The application QoS, i.e., the LMQB 102, monitors classified traffic from various wireless and wireline access networks and selects an access network to deliver service to the end user based on user consent, policies, resource availability, service level agreement (SLA), and efficiency of utilization of resources. Besides performing these functions, embodiments of the LMQB also utilize the user's location and presence information in selecting an appropriate access network among the available access networks. The selection of the appropriate access network depends at least in part on the user's QoS needs and/or on the needs of the data service serving the user.

Traditionally, a user accesses services from a single access network and a single end terminal/device and the service data passes over that single access network independent of whether or not the access network can meet the end user's QoS needs. Normally, in a single access network environment including, for example, the next generation wireless access network shown in FIG. 1, the traffic travels through the shaded region in the figure. In the event that adequate resources are not available in the single or individual access network to meet a requested level of QoS, the access network responds negatively to the end user's request for a specified QoS and the user generally has to settle for a reduced QoS.

In a traditional setting, if the user has a choice of a different access network, the user may reinitiate the request for a specified QoS. However, the burden rests with the user to try out different possibilities.

In contrast, embodiments of the present invention provide a LMQB service 102 that determines the user's presence in one or more available access networks and manages the last mile of the network, e.g., manages the QoS received by the user. For example, the LMQB service 102 can redirect the session to an available access network that meets the user's requested level of QoS.

Stated another way, embodiments of the present invention provide methods and systems for monitoring resources available in multiple access networks and for monitoring a user's location and presence in different access networks. When a QoS request originates from a user, embodiments of the invention automatically search for and select an appropriate access network given the specified QoS. In one embodiment, the LMQB then informs the user of the selected access network and/or QoS, and data service delivery begins.

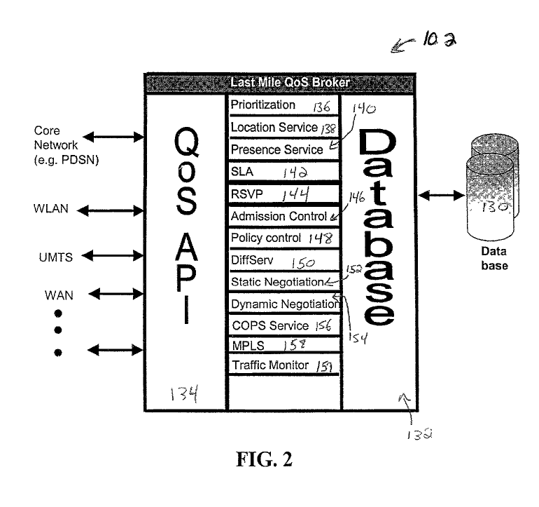

FIG. 2 shows a functional block diagram of one embodiment of the LMQB 102 of FIG. 1. The LMQB 102 contains QoS application programming interfaces (API) 134 to various wireless network QoS entities. According to embodiments of the invention, the QoS APIs are APIs that comply with the QoS API specification being developed through the operation support systems QoS API JAVA specification request (JSR90 OSS Quality of Service API [online], [retrieved on Sep. 24, 2001]. Retrieved from the Internet<URL: http://jcp.org/isr/detail/090.jsp>, and incorporated herein by reference in its entirety). The LMQB 102 also maintains it's own database 130.

The LMQB 102 includes a number of modules. The prioritization module 136 prioritizes packets by assigning suitable diffserv codepoints based on the QoS requested via the QoS API. A codepoint is a specific value in the differentiated services. The location service 138 obtains data related to a user's location from the location server and provides the location data to the static and/or dynamic negotiation modules 152, 154. Similarly, presence server 140 obtains data related to a user's presence in one or more access networks from the presence server and provides the presence data to the static and/or dynamic negotiation modules 152, 154.

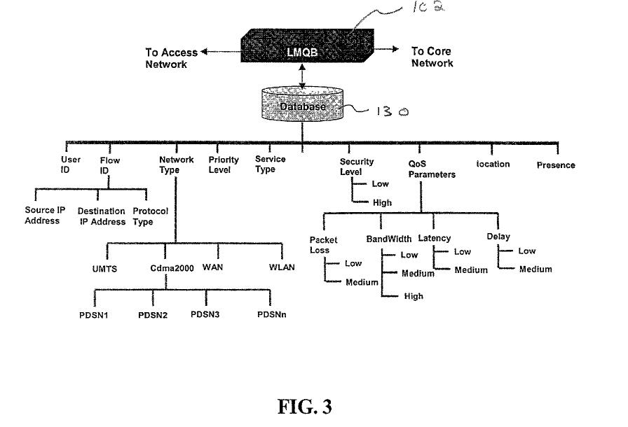

The Service Level Agreement (SLA) module 142 receives a SLA request for a particular user. According to one embodiment, a service level agreement is defined in terms of throughput, delay, jitter and packet loss. The LMQB 102 collects the types of data shown in FIG. 3 and stores the data in database 130. The SLA module 142 obtains SLA data related to the agreement between the user and a service provider from the database 130. The SLA 142 forwards the SLA data to a billing server 103 (shown in FIG. 1) so that the user can be billed accordingly.

The RSVP module 144, the DiffServ module 150, and the multiprotocol label switching (MPLS) module 158 are also part of the desktop and network elements. The RSVP module 144 receives requests for specified QoS through the QoS API. The requests derive from a host, router, or user and comply with the RSVP protocol. The DiffServ module 150 receives DiffServ compliant data regarding the classification of network traffic through the QoS API. Similarly, the MPLS module 158 receives MPLS compliant data regarding the classification of network traffic through the QoS API. Each of these modules can support QoS in various portions of the network.

The admission control module 146 communicates with an access network. The admission control module 146 functions to admit or reject an end user request for the use of network resources.

The policy control module 148 communicates with the policy database. Each access network has its own policy database. The policy control module 148 functions to ensure that local administrative policies are not violated.

The static negotiation module 152 obtains from the database 130 data related to available access networks and the QoS resources associated with the available access networks. The static negotiation module 152 establishes quality of service parameters for the duration of the mobile's data session.

Similarly, the dynamic negotiation module 154 obtains from the database 130 data related to available access networks and the QoS resources associated with the available access networks. The dynamic negotiation module 154 establishes and modifies QoS parameters dynamically during a voice, a video, or a data session. The dynamic negotiation module responds to requests for QoS changes while a session is in progress. Such requests may be originated by end users.

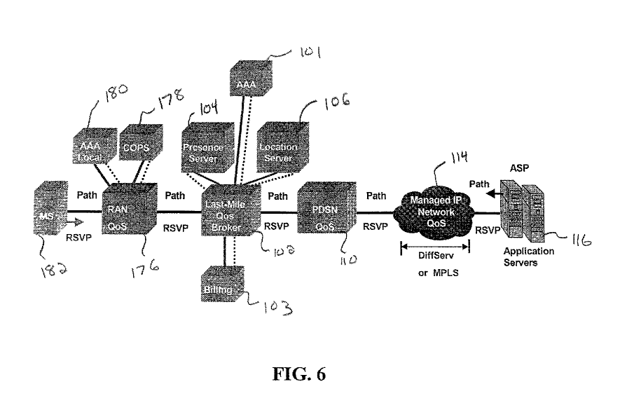

The common open policy service (COPS) module 156 communicates with the COPS server 178 (shown in FIG. 6), possibly co-located with the PDSN. In one embodiment, the COPS module 156 communicates with the COPS server 178 through the radio access network (RAN). According to another embodiment, the COPS server 178 can also be part of the IP backbone. The COPS module 156 implements policy decision and policy enforcement points. The COPS protocol is a simple query and response protocol that can be used to exchange policy information between a policy server (Policy Decision Point or PDP) and its clients (Policy Enforcement Points or PEPs). One example of a policy client is an RSVP router that must exercise policy-based admission control over RSVP usage. At least one policy server usually exists in each controlled administrative domain. The basic model of interaction between a policy server and its clients is compatible with a framework document for policy based admission control, i.e., RFC 2748 (D. Durham. The COPS (Common Open Policy Service) Protocol Network Working Group [online], [retrieved on 2001 Oct. 4, 2001]. Retrieved from the Internet<URL: http://asg.web.cmu.edu/rfc/rfc2748.html> and incorporated herein by reference in its entirety). RFC 2748 provides more details regarding the COPS protocol.

The traffic monitor module 159 communicates with network resources including the access networks and functions to monitor the traffic passing through the network resources.

The system components perform the following functions. The LMQB 102 performs service co-ordination among wireless access networks. The LMQB, i.e., the dynamic or the static negotiation module, acquires a knowledge base of the surrounding networks using its databases (see FIG. 3), and location and presence servers. In addition, either module derives, from the resource availability, the data services distribution across the network for a given time period. The LMQB 102 may exchange information periodically in the background much like routers exchange routing information periodically. This type of information enables the broker to aggregate services with the same characteristics.

The dynamic negotiation module performs dynamic resource allocation based on traffic demand. The broker periodically signals all the QoS network entities for resource and policy information. Once the registration entity registers a mobile user, the user can begin to utilize QoS services. Since mobile phones that are part of 2.5G and 3G networks are always on, registration in such networks is automatic. In 2G networks, the Home Location Register registers mobile users when the user turns on the mobile device or when the user moves into a new location.

When the user requests a QoS service, the LMQB assigns an access network that is appropriate for the requested QoS by negotiating with the network entities on a mobile user's behalf. If the quality of service required by the mobile user changes or degrades during a session, the broker re-assigns resources accordingly. According to one embodiment, if none of the access networks can provide the requested QoS then the system provides the closest QoS it can provide.

The Traffic Monitor module 159 performs tracking of resources and dynamic updating. The module 159, operating in the background, exchanges resource availability or QoS related status information with other network entities. The Traffic Monitor module 159 updates the database shown in FIG. 3 in real time.

The Traffic Monitor module 159 also performs rerouting of traffic to an appropriate access network based on location of the mobile user and on service demand. When the home location registration (HLR) or visitor location registration (VLR) registers the mobile in the network, the HLR or VLR have the mobile's location information. Once the location service 138 and/or presence service 140 obtains the position of the mobile user via the HLR and/or VLR, and once the module 159 obtains all the traffic activities within various networks elements relevant to the mobile user, the LMQB 102 can determine which network elements it should select for the mobile user's data traffic.

The Traffic Monitor module 159 also performs creation and maintenance of QoS traffic distribution based on historical data. One of the key components of the broker 102 is its traffic database. The LMQB can determine information such as network utilization, service modeling and profile, and network bottlenecks by performing statistical analysis of traffic data. The periodic data obtained by the LMQB 102 from other QoS brokers on the access network is used for the analysis. The data includes relevant QoS parameters such as bandwidth used in each access network.

According to one embodiment, the LMQB broker negotiates a suitable access network and ensures end-to-end quality of services. It interfaces with wireless and wireline network QoS entities using a standard open application program interface (API). As noted above, according to embodiments of the invention, the QoS APIs are APIs that comply with the QoS API specification being developed through the operation support systems QoS API JAVA specification request (JSR90 OSS Quality of Service API [online], [retrieved on Sep. 24, 2001]. Retrieved from the Internet<URL: http://jcp.org/jsr/detail/090.jsp>).

The LMQB 102 of FIG. 1 uses a database structure, one embodiment of which is shown in FIG. 3. The database structure 130 consists of elements such as user ID, Flow ID, Network type, Priority level, Service type, Security level, QoS parameters, location, and presence. These elements further sub-divide into various categories. For example, the flow ID includes source IP address, Destination IP address, and Protocol type. The network type element includes a variety of network type categories such as UMTS, CDMA2000, WAN, and WLAN. The QoS parameters can includes a variety of parameter categories such as packet loss, bandwidth, latency and delay.

The LMQB 102, with its database resources, groups traffic with the same characteristics and priorities and routes them accordingly. Once the real time traffic is routed through a particular path of the network, the LMQB periodically updates its databases to ensure it provides end-to-end quality of service. If the user decides to change QoS requirements in the midst of a session, the LMQB dynamically updates the database and re-allocates new resources and establishes a path that meets the requested quality of service. In case such a path is not available, the LMQB informs the user accordingly.

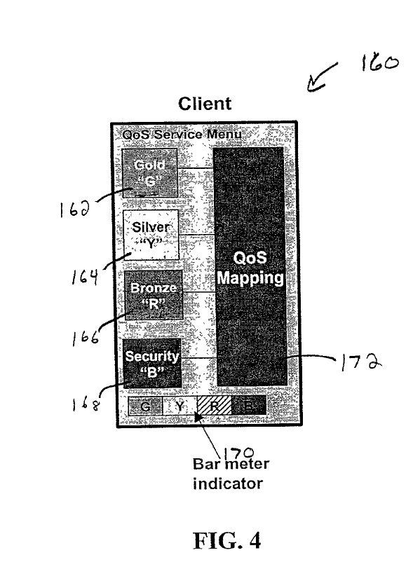

With reference to FIG. 4, one embodiment of a wireless device according to the invention has a QoS LED (light emitting diode) indicator or a bar color meter 170 showing the level of QoS and security associated with a particular data service. In FIG. 4, we consider a case in which a user device is loaded with a quality of service software.

According to the illustrated embodiment, the user device has quality of service selection software that provides a menu of options. The menu of options includes gold 162, silver 164, bronze 166 and security 168 service. The software includes QoS mapping module 172 which maps a selection to a set of QoS parameters. The QoS mapping module 172 maps Gold service (coded as “G”) to the highest end to end quality of service parameters a network can provide, silver service (coded as “Y”) to the medium end to end quality of service parameters a network can provide, and bronze service (coded as “R”) to the lowest end to end quality of service parameters a network can provide.

The QoS mapping module 172 also maps security service (coded as “B”) to a high or typical security level for an end-to-end service delivery. The user can select the security level he/she wants. When the wireless device uses encryption to provide greater security, the user device encrypts the packets before sending and the end node decrypts the packets upon receiving according to methods known in the art. FIG. 4 illustrates only one embodiment of the invention. As will be clear to those of skill in the art, there are a variety of ways in which to allow a user to select a desired QoS.

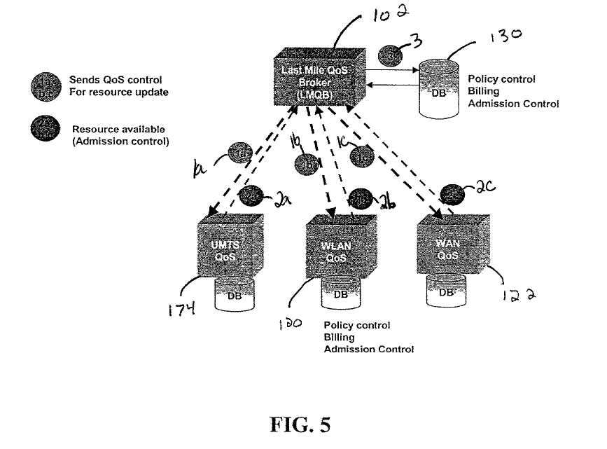

With reference to FIG. 5, according to embodiments of the invention, each access network has its own local QoS broker. In one embodiment, the access networks can use a standard protocol, for example, 801.1 p on a LAN. The LMQB broker 102 sends a periodic signal in the background to all QoS brokers associated with the wireless, wireline, and PDSNs (Packet Data Serving Nodes) to get updates on the availability of resources. For example, as illustrated, LMQB 102 sends QoS control signals 1a, 1b, 1c to UMTS QoS broker 174, WLAN QoS broker 120, and WAN QoS broker 122, respectively. The access network QoS brokers send 2a, 2b, 2c resource available (admission control) signals back to the LMQB 102. Upon receiving updates, the LMQB 102 updates 3 its database 130 so that the LMQB can effectively utilize the network and adapt to varying traffic.

FIG. 6 illustrates one embodiment of a single wireless network infrastructure. The infrastructure includes a mobile station (MS) 182, and a radio access network (RAN) 176 that interfaces the mobile user to a packet data-serving node (PDSN) 110 through a LMQB 102. A high-speed data link connects the RAN to the local authentication, administration, and accounting (AAA) server 180, and the common open policy service (COPS) 178. The COPS 178 implements policy decision and policy enforcement points. In addition, the LMQB has access to a presence server 104, which determines the mobile's presence within the wireless or wired network, and the location server 106, which pinpoints the position of the mobile user. The LMQB 102 also has access to the AAA server 101 and the billing server 103. A high-speed link such as an optical fiber link connects the PDSN 110 and the managed IP network QoS broker 114. In the illustrated embodiment, an application server 116 stores multimedia content and delivers the content as requested.

FIG. 6 illustrates an LMQB environment in which the radio access network (RAN) is a typical CDMA network and the backbone includes a managed IP network. The LMQB provides an interactive class of services (e.g., Video down loading). Assuming the mobile user is roaming and is already registered with the system by a registration request sent to the HLR via the PDSN and the radio access network (RAN), the HLR or VLR authenticates the mobile user. As the mobile user roams between networks, the presence server detects the presence of the user's device in different networks and updates its database. Note that the mobile user can maintain a presence simultaneously or concurrently in more than one network. Besides tracking a user's presence, the system uses a location server to track the mobile user's location.

For the scenario described below, the mobile is registered and active, i.e., powered on. The application server 116 shown in FIG. 6 initiates an RSVP PATH message. Upon receiving the message, the managed IP network QoS broker 114 treats this message in one of a number of possible ways: 1) The managed IP network QoS broker 114 marks the request appropriately and, when data packets corresponding to this RSVP flow arrive, the managed IP network QoS broker 114 labels them with a suitable DiffServ code point (DSCP) for prioritized treatment by routers within the managed IP network; 2) The managed IP network QoS broker 114 employs a multiprotocol label switched path (MPLS) within the managed IP network; and 3) The managed IP network QoS broker 114 uses a combination of MPLS and DiffServ.

Once the managed IP network QoS broker has performed suitable mapping, the original RSVP PATH message then propagates out from the managed IP network to the mobile service 182. The application software that resides within the mobile station 182, requests a specific level of QoS by using RSVP. The network delivers the RSVP message to the network entities. Upon receiving this message, the RAN QoS broker 176 allocates the air link radio resources and hands the message over to the LMQB 102.

The LMQB assigns the mobile user suitable resources by matching its database to that of the reservation requirement requested by the mobile user/application. It is entirely likely that the LMQB may recommend to the user a different access network and a different mobile terminal or end user device than the mobile user is currently using; the LMQB may use short message service (SMS) or session initiation protocol (SIP) to advise the user. If the user accepts the recommendation, the session proceeds at the requested QoS. If the user does not accept the recommendation then the session proceeds with the QoS available from the default access network and mobile terminal.

SIP is a text-based application-layer control protocol. It creates, modifies, and terminates sessions with one or more participants. Such sessions include Internet telephony and multimedia conferences Once the reservation protocol in combination with the LMQB reserves the appropriate QoS parameters across the network, the mobile can begin the session (e.g., video down loading) using an assigned high-speed data connection traffic channel. According to one embodiment, if the LMQB determines that a first network element will fall short of meeting the requested QoS, the LMQB transitions the flow from the first network element to a second network element without the involvement of the mobile in an attempt to maintain the requested QoS.

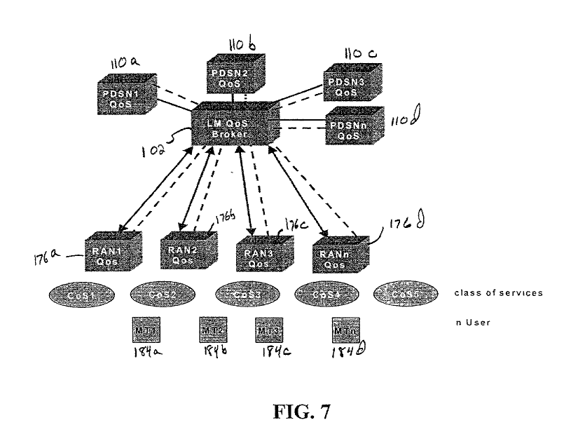

In an embodiment shown in FIG. 7, a single LMQB 102 supports many RANs 176a, 176b, 176c, 176d and PDSN QoS brokers 110a, 110b, 10c, 110d. These RANs could be formed out of picocells, microcells, or macrocells. They can be part of a single network or part of multiple networks. Hence, as a mobile user roams between sub networks or networks, the traffic to/from the mobile accordingly transitions between sub networks and networks. Therefore, according to one embodiment, the LMQB's task is to maintain service continuity with a level of QoS that the mobile requires. The LMQB prioritizes and aggregates services based on traffic characteristics generated by each mobile user.

The prioritization criterion used by LMQB is based on class of service requested such as, for example conversational, time-sensitive applications (e.g., 911, emergency) or high-end user premium selection. Each mobile user can subscribe to a qualitative QoS criterion such as gold, silver, or bronze and level of security desired. According to one embodiment, a QoS mapping module on the requesting mobile device or in the LMQB can map the qualitative QoS criterion onto QoS requirements with regard to delay, jitter, packet loss, bandwidth, etc. One possible mapping is shown in the following Table for illustrative purposes.

QoS attributes

| Rating | Delay | Jitter | Packet Loss | Bandwidth |
|---|---|---|---|---|
| Gold | low | low | low | high |
| Silver | medium | medium | medium | medium |
| Bronze | medium | medium | medium | low |

Security

Security level

| Service Type | high | Low |
|---|---|---|
| Multimedia | | x |
| E-mail | x | |

The LMQB service can assign each parameter a probability distribution to guarantee the appropriate level of QoS. For example, the LMQB service can assign gold service a minimum latency and a maximum bandwidth, which can be translated to a mean value and a plus or a minus standard deviation for both latency and bandwidth. Similarly, the LMQB service can map a bronze service onto differential services code point (DSCP) at the low end of prioritization. DiffServ rules define how a packet flows through a network based on a 6 bit field (the Differentiated Services Code Point) in the IP header. The Differentiated Services Code Point specifies the “per hop behavior” (bandwidth, queuing and forward/drop status) for the packet or message.

One embodiment of a LMQB service charges users based on QoS level usage. In the same context, a user can also select a high security for an E-mail transmission. The service level agreement (SLA) can be between service provider and the user or between service providers. Regardless of the type of SLA, the LMQB collects the user's quality of service data, which a billing Operation Support System (OSS) then uses for billing purposes. The LMQB can route flows suitably to a PDSN 110a, 110b, 110c, 110d so as to optimize utilization of the network and to meet requested end-to-end QoS.

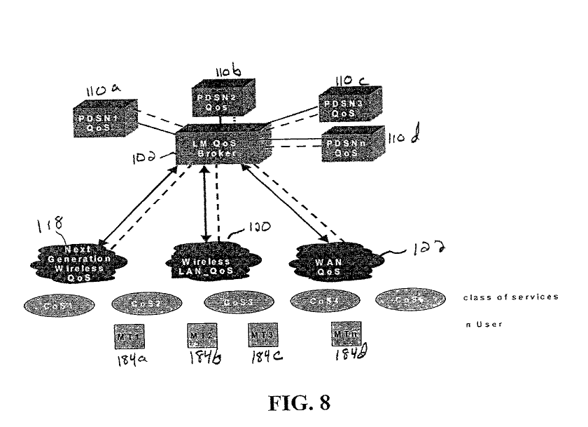

FIG. 8 shows a number of mobile users 184a, 184b, 184c, 184d using a number of services and accessing various networks. Since the LMQB 102 has a historical traffic profile, resource data, and location data of each PDSN, it directs traffic accordingly. Network designers and cell site engineers allocate some head room (i.e., they over design the network) during deployment so that there is enough capacity for traffic demand. A cell site engineer is one who is responsible for simulating the environment based on terrain, traffic, geographical location, power and other requirements before the deployment of base stations.

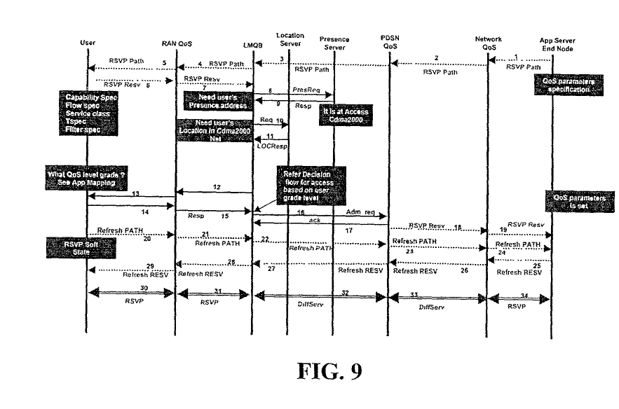

With reference to FIG. 9, the following steps illustrate the operation of one embodiment of the system of FIG. 6 in the 3G wireless environment. An end node or a source generates (1) an RSVP path message. This per-flow QoS signaling mechanism enables the end node to include parameters such as transmission rate, bandwidth, or other quality of service capabilities. The RSVP path message propagates (2) through the network QoS broker to the Packet Data Serving Node (PDSN). The PDSN_QoS broker then forwards (3) the RSVP path request to the LMQB. The LMQB sends (4) the RSVP path request to the RAN QoS broker. The RAN QoS broker broadcasts (5) the message to the mobile users.

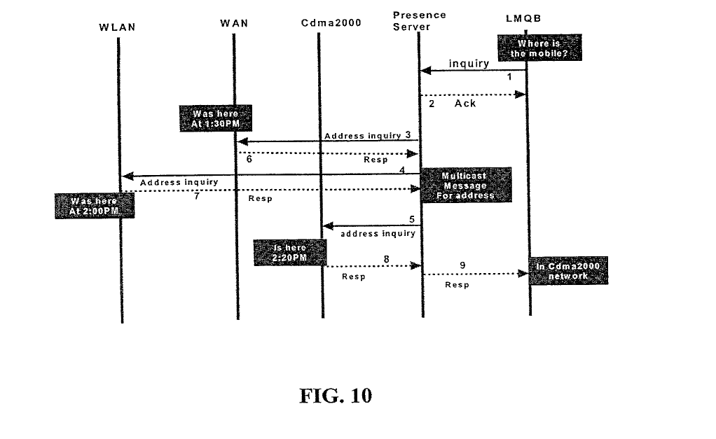

Once a mobile user receives the resource reservation path message, it responds (6) with its QoS request via an RSVP Resv message. The RAN QoS broker sends (7) the RSVP resv message to the LMQB. After receiving the RSVP Resv message from the RAN, the LMQB determines whether the QoS request from the user (step (6) above) can be met using the originating access network Assuming the originating access network can not meet the requested QoS, the LMQB requests (8) the presence server for mobile's presence within the network (see FIG. 10). The LMQB receives (9) mobile's presence address information from the presence server. With this information the LMQB determines that the mobile user is registered, for example, with the Cdma2000 network. The LMQB requests (10) the location server for the exact location of the mobile within the Cdma2000 network. The Location server responds (11) to LMQB's request.

At this point, the LMQB recommends (12) a different access network that is appropriate for the requested QoS. In other words at step (6), the user provides a QoS request in the Resv message. At step (12), the LMQB provides its recommendation to the end user on which access network can provide an appropriate QoS level given the request and given the network resources. The RAN QoS broker delivers (13) the request/recommendation to the mobile user.

The mobile user makes a QoS selection, e.g., Gold, and responds (14) to the RAN_QoS broker. Upon receiving (15) the response, the LMQB makes a decision as to which PDSNs meet the mobile's QoSs needs (see FIG. 10). Once the admission and policy control modules of the LMQB determine admission and policy control for the mobile user and the session, the LMQB requests (16) the chosen PDSN QoS broker to send the request to the next hop. Upon receiving the request from the LMQB, the PDSN QoS broker responds (17) that it will allocate the QoS level requested. The PDSN QoS broker forwards (18) to the network QoS broker the desired quality of service attributes. The Network QoS broker contacts (19) the end node, i.e., an application server, based on the destination address contained in the request. The end node obtains the mobile station capabilities from the request and sets its QoS parameters accordingly.

The mobile sends (20) a refresh path message to the ending node. Each network entity propagates (21, 22, 23, 24) this message to the next hop along the path. Since routers only maintain soft states with regard to RSVP signaling, all the network entities periodically refresh RSVP PATH messages. Upon receiving the Refresh path message, the ending node sends (25, 26, 27, 28, 29) an acknowledgement via a Refresh RSVP message. All the network entities in the path propagate the same message. Receipt of this message by all the network entities in the path establishes an RSVP bandwidth reservation for a mobile user to communicate with an end node. In this way, the appropriate network entities open (30, 31) an end-to-end dedicated quality of service data channel. The LMQB maps (32, 33) the RSVP message into a differentiated service code point (DSCP) and the egress LMQB performs the inverse mapping, i.e., it reinitiates the original RSVP message before forwarding it to the PDSN_QoS. The egress of the Network_QoS broker converts (34) the Diffserv service into an RSVP before forwarding to the end node.

FIG. 10 shows the signal flow between the LMQB, the presence server, and various network entities referred to above with respect to steps (8) and (9) of FIG. 9. The LMQB queries (1) the presence server for mobile user's current address information. The presence server sends back (2) an acknowledge message acknowledging that it has received the inquiry. The presence server sends out (3, 4, 5) a multicast message to all access networks (e.g., WAN, WLAN, Cdma200 and UMTS). In the illustrated example, upon receiving the message, the WAN QoS broker responds (6) to the presence server with the time the mobile user in question was registered and present in the WAN. Similarly, the WLAN QoS broker and the Cdma2000 QoS broker respond (7, 8) to the presence server with the time the mobile user in question was registered and present in the WLAN and Cdma2000 network, respectively. From the time stamp information, the presence server determines the mobile's current address and responds (9) to the LMQB.

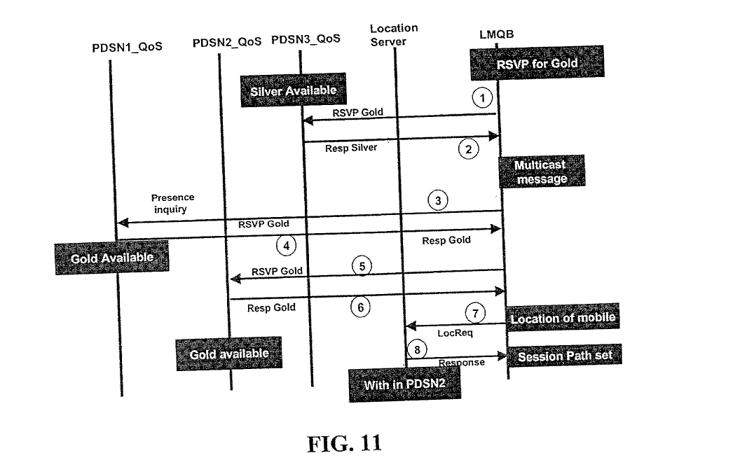

In FIG. 11, one embodiment of a LMQB obtains QoS availability data from various network entities and selects at least one network entity based on the QoS availability data. The LMQB sends (1, 3, 5) a multicast message to various PDSNs with the Gold QoS requirements. In the illustrated example, upon receiving the requested QoS level, the PDSN 3 responds with its resource availability to the LMQB indicating that it can only deliver silver level QoS. PDSN1 and PDSN2, on the other hand, respond (4, 6) to the LMQB that they can meet the requested QoS level. After analyzing all the responses, the LMQB queries (7) the location server for the exact location of the mobile. Upon receiving (8) the location information, the LMQB selects a network entity on the mobile user's behalf.

The LMQB exchanges information with the WLAN, WAN and other access networks in the same manner that the LMQB exchanges information with the PDSNs as illustrated in FIG. 10. In one embodiment, the LMQB exchanges information with the access networks in response to a QoS request from an end user device. In another embodiment, the exchange of information takes place periodically.

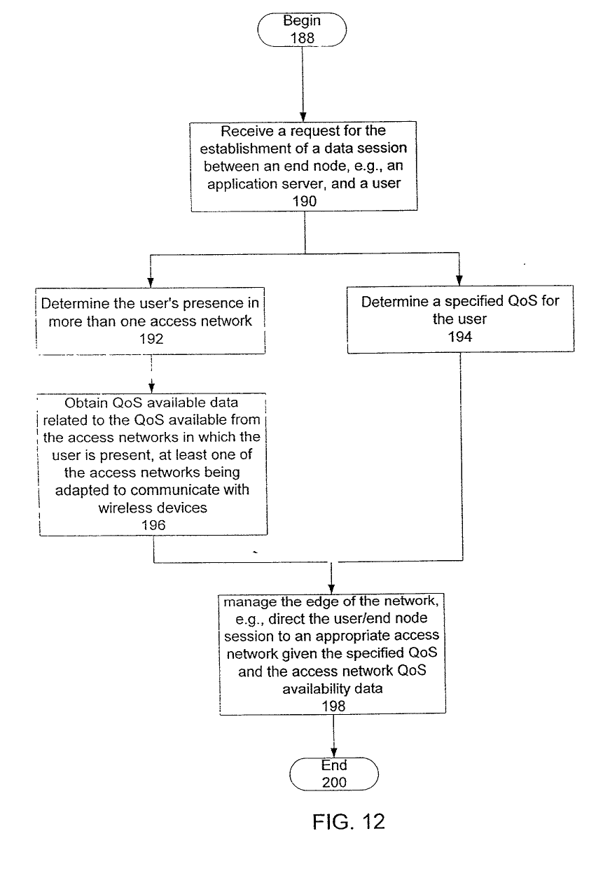

With reference to FIG. 12, one embodiment of a method according to the present invention begins 188 with the receipt 190 of a request for the establishment of a data session between an end node, e.g., an application server, and a user 190. The method then determines 192 the user's presence in more than one access network. The method also determines 194 a specified QoS for the user and/or session. The method obtains 196 QoS available data related to the QoS available from the access networks in which the user is present. At least one of the access networks communicates with wireless devices. In addition, the method manages 198 the edge of the network, e.g., the method directs the user/end node session to an appropriate access network given the specified QoS and the access network QoS availability data.

Thus embodiments of the present invention provide methods and systems that coordinate between various wireless/ wireline access networks to allocate resources to meet end-to-end QoS needs and to increase network utilization by distributing traffic. Embodiments of the invention track network resources and allocate traffic to networks elements dynamically. Due to the ability to track resources, these embodiments of the invention reduce the data call blocking rate. Furthermore, according to one version of the present invention, network providers have access to more than one network across which they can carry traffic to end users, for example, as at Internet peering points.

Peering is a relationship between two or more small- or medium-sized ISPs in which the ISPs create a direct link between each other and agree to forward each other's packets directly across this link instead of using the standard Internet backbone. For example, suppose a client of ISP X wants to access a web site hosted by ISP Y. If X and Y have a peering relationship, the HTTP packets will travel directly between the two ISPs. In general, this results in faster access since there are fewer hops. And for the ISPs, it's more economical because they don't need to pay fees to a third-party Network Service Provider (NSP). Peering can also involve more than two ISPs, in which case all traffic destined for any of the ISPs is first routed to a central exchange, called a peering point, and then forwarded to the final destination.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for providing quality of service to the edge of a network, the edge of the network including a plurality of access networks, the method comprising:
determining a user's presence in more than one of the plurality of access networks;
determining a specified QoS for the user;
obtaining QoS available data related to the QoS available from the plurality of access networks in which the user is present, at least one access network being adapted to communicate with wireless devices; and
managing the edge of the network based at least in part on the specified QoS for the user and on the QoS available data.

2. The method of claim 1, wherein managing the edge of the network comprises:
in response to the QoS available data, directing a session for the user to an access network that is appropriate for the specified QoS.

3. The method of claim 1, wherein managing the edge of the network comprises managing the QoS provided to the user.

4. The method of claim 1, wherein the network comprises network resources and wherein managing the edge of the network comprises dynamically allocating network resources.

5. The method of claim 1, wherein managing QoS comprises tracking user device movement among access networks during a user session.

6. The method of claim 1, wherein the access networks are selected from the group of access networks consisting of WAN, WLAN, UMTS, Bluetooth, hiperLAN, WCDMA and CDMA networks.

7. The method of claim 1, wherein the access networks include at least one of a radio access network and a packet data serving node.

8. The method of claim 1, wherein the specified QoS includes parameters selected from the group of parameters consisting of rating, delay, jitter, packet loss, and bandwidth.

9. The method of claim 8, wherein a specified QoS for the user includes a specified mean value and standard deviation for QoS parameters.

10. A method for providing quality of service to the edge of a network, the edge of the network including a plurality of access networks, the method comprising:
determining a user's presence in more than one of the plurality of access networks;
receiving a request from the user for a specified QoS;
obtaining QoS available data related to the QoS available from the plurality of access networks in which the user is present, at least one access network being adapted to provide access to wireless devices; and
in response to the QoS available data, directing a session for the user to an access network that can meet the specified QoS.

11. The method of claim 10, wherein the method dynamically obtains QoS available data and dynamically directs a session.

12. The method of claim 10, wherein the network comprises network resources and wherein the method further comprises obtaining traffic data from the network resources and dynamically allocating network resources based at least in part on the traffic data.

13. The method of claim 10, wherein the method further comprises tracking user device movement among access networks during a user session.

14. The method of claim 10, wherein the access networks are selected from the group of access networks consisting of WAN, WLAN, UMTS, Bluetooth, hiperLAN, WCDMA and CDMA networks.

15. The method of claim 10, wherein the access networks include at least one of a radio access network and a packet data serving node.

16. The method of claim 10, wherein the specified QoS includes parameters selected from the group of parameters consisting of rating, delay, jitter, packet loss, and bandwidth.

17. The method of claim 16, wherein a specified QoS for the user includes a specified mean value and standard deviation for QoS parameters.

18. A system for providing quality of service to the edge of a network, the edge of the network including a plurality of access networks, the system comprising:
a database operative to store data associated with access network resources;
a LMQB device in communication with the database, having an interface for communicating over a network, and operative to:
determine a user's presence in more than one of the plurality of access networks;
determine a specified QoS for the user;
obtain QoS available data related to the QoS available from the plurality of access networks in which the user is present, at least one access network being adapted to communicate with wireless devices; and
manage the edge of the network based at least in part on the specified QoS for the user and on the QoS available data.

19. The system of claim 18, wherein the interface includes a QoS API.

20. The system of claim 18, wherein the LMQB device comprises:
a RSVP module adapted to receive RSVP data from the interface and operative to reserve resources in accordance with the RSVP data.

21. The system of claim 18, wherein the LMQB device comprises:
a DiffSERV module adapted to receive DiffSERV data from the interface and operative to classify data in accordance to the DiffSERV data.

22. The system of claim 18, wherein the LMQB device comprises:
a static negotiation module adapted to receive data associated with network resources from the database and operative to establish quality of service parameters for the duration of the mobile's data session.

23. The system of claim 18, wherein the LMQB device comprises:
a dynamic negotiation module adapted to receive data associated with network resources from the database and to receive a request for a change of a specified QoS while a session is in progress, the dynamic negotiation module being operative to establish and modify quality of service parameters dynamically during a mobile's data session.

24. The system of claim 18, wherein the LMQB device comprises:
a service level agreement (SLA) module adapted to receive a request from a user and operative to obtain SLA data from the database related to the agreement between the user and a service provider in response to the request.

25. The system of claim 18, wherein the LMQB device comprises:
a traffic monitor module adapted to communicate with the access networks and operative to obtain the resource availability of the access networks and to route traffic based at least in part on a user's presence and on service demand.

26. A wireless device adapted for communicating with an access network comprising:
means for receiving QoS selection data from a user; and
means for communicating the QoS selection data to an access network.

27. The wireless device of claim 26, wherein the receiving means comprises a selection menu means for providing a menu of QoS selections to a user.

28. The wireless device of claim 27, wherein the wireless device further comprises means for mapping a QoS selection data received from the selection menu means to QoS parameter data and for supplying the QoS parameter data to the means for communicating.

29. A memory for storing data for access by an application program being executed on a data processing system, the memory comprising:
access network records for storing data related to the resources available from a plurality of access networks; and
QoS parameter records for storing data related to QoS parameters obtained in connection with a user session, transmission of the user session occurring over at least one of the plurality of access networks.

30. A method for providing quality of service to the edge of a network, the edge of the network including a plurality of access networks, the method comprising:
determining a user's presence in more than one of the plurality of access networks by using a LMQB to query a presence server causing the presence server to send a multicast message to appropriate network elements and to receive back from each appropriate network element an indication of whether the user is present in a particular access network;
determining a specified QoS for the user;
obtaining QoS available data related to the QoS available from the plurality of access networks in which the user is present by using the LMQB to send a multicast query message to identified network elements, at least one access network being adapted to communicate with wireless devices; and
in response to the QoS available data, directing a session for the user to an access network that can meet the specified QoS.

31. The method of claim 30, wherein the method dynamically obtains QoS available data and dynamically directs a session.

32. The method of claim 30, wherein the network comprises network resources and wherein the method farther comprises obtaining traffic data from the network resources and dynamically allocating network resources based at least in part on the traffic data.

33. The method of claim 30, wherein the method further comprises tracking user device movement among access networks during a user session.

34. A system for providing quality of service to the edge of a network, the edge of the network including a plurality of access networks, the system comprising:
a database operative to store data associated with access network resources;
a LMQB device in communication with the database, having an a QoS API interface for communicating over a network, the LMQB device comprising
means for determining a user's presence in more than one of the plurality of access networks;
means for determining a specified QoS for the user;
means for obtaining QoS available data related to the QoS available from the plurality of access networks in which the user is present, at least one access network being adapted to communicate with wireless devices; and
means for managing the edge of the network based at least in part on the specified QoS for the user and on the QoS available data.

35. The system of claim 34, wherein the LMQB device comprises:
a RSVP module adapted to receive RSVP data from the interface and operative to reserve resources in accordance with the RSVP data.

36. The system of claim 34, wherein the LMQB device comprises:
a DiffSERV module adapted to receive DiffSERV data from the interface and operative to classify data in accordance to the DiffSERV data.

37. The system of claim 34, wherein the LMQB device comprises:
a static negotiation module adapted to receive data associated with network resources from the database and operative to establish quality of service parameters for the duration of the mobile's data session.

38. The system of claim 34, wherein the LMQB device comprises:
a dynamic negotiation module adapted to receive data associated with network resources from the database and to receive a request for a change of a specified QoS while a session is in progress, the dynamic negotiation module being operative to establish and modify quality of service parameters dynamically during a mobile's data session.

39. The system of claim 34, wherein the LMQB device comprises:
a service level agreement (SLA) module adapted to receive a request from a user and operative to obtain SLA data from the database related to the agreement between the user and a service provider in response to the request.

40. The system of claim 34, wherein the LMQB device comprises:
a traffic monitor module adapted to communicate with the access networks and operative to obtain the resource availability of the access networks and to route traffic based at least in part on a user's presence and on service demand.
